(19) United States
(12) Patent Application Publication
(10) Pub. No.: US 2022/0410032 A1
(43) Pub. Date: Dec. 29, 2022

(54) METHOD FOR EXTRACTING ACTIVE COMPONENTS FROM PLANTS AND DEVICES FOR SUCH PURPOSE

(71) Applicants: Cristian Camilo Diaz Merchan, Bogota (CO); Adriana Patricia Saboya Ruiz, Bogota (CO)

(72) Inventors: Cristian Camilo Diaz Merchan, Bogota (CO); Adriana Patricia Saboya Ruiz, Bogota (CO)

(73) Assignee: Ki Cannabic Science SAS, Bogota (CO)

(21) Appl. No.: 17/756,210

(22) PCT Filed: Nov. 18, 2020
(86) PCT No.: PCT/IB2020/060877

§ 371 Date: May 19, 2022

(30) Foreign Application Priority Data
Nov. 21, 2019 (CO) NC2019/0013031

(51) Int. Cl. B01D 15/10; C11B 1/10; B01D 11/02

(52) U.S. Cl. CPC B01D 15/10; C11B 1/10; B01D 11/02

(57) ABSTRACT

A method and apparatus for extracting active components from a plant material by: introducing the material containing the active components in an extraction chamber: introducing a hydrofluorocarbonated compound in a tank at a pressure between 482.6 kPa and 1,447.9 kPa (70 psi to 210 psi): introducing ethanol in a receptacle; mixing the hydrofluorocarbonated compound with ethanol; allowing the mixture to reach the plant material; allowing the mixture enriched with ethanol and the hydrofluorocarbonated compound to flow out of the extraction chamber and into a tank; allowing the ethanol to evaporate and become separated from the residual mixture slower than the hydrofluorocarbonated compound; optionally, the hydrofluorocarbonated compound is recovered by condensing and returning it to the pressurised tank; optionally, the ethanol is recovered by condensing and returning it to the mixing receptacle.

### CROSS REFERENCE TO RELATED APPLICATION

This application is a national stage entry of PCT/IB2020/060877 filed Nov. 18, 2020, under the International Convention and claiming priority over Colombian Patent Application No. NC2019/0013031 filed Nov. 21, 2019.

### FIELD OF THE INVENTION

This patent application refers to a process for extracting active components from plant material and to the apparatus that allows said extraction. More particularly, the present invention relates to a process for extracting cannabinoids and devices that allow such extraction.

### BACKGROUND OF THE INVENTION

The process of extracting substances with pharmacological activity from plant biomass is a common practice what involves long hours of processing and multiple steps of extraction and purification with solvents that are often contaminants. This means that the efficiencies achieved are not high, there is an environmental impact, and it is necessary to explore more efficient alternatives with less impact on the environment. Additionally, the compounds of pharmacological interest are normally present in the plant mixed in complex matrices with other substances that are undesirable, making selective extraction methodologies necessary.

The extraction methods that are currently being used in the pharmaceutical industry involve the use of solvents in a liquid state. In many cases, liquefied gases are used v.gr. CO₂ or butane at supercritical or subcritical temperature and pressure to act as liquid solvents and that can extract the substances of interest. The equipment that is required must withstand very high pressures, they are very expensive, and, in many cases, they are highly dangerous because they are flammable and explosive gases v.gr. the butane.

Extraction systems are also used by means of “super cooling” around −50° C. This allows solvents such as ethanol to modify their properties and achieve selective extraction. This methodology presents as a drawback the use of large amounts of solvent that must then be removed, forcing the use of additional evaporation equipment.

For its part, in the emerging market of the cannabis industry whether for medicinal, scientific or adult market purposes extraction technologies have been developed and adapted that allow the separation of the active ingredients of the Cannabis sativa L. The state of the art teaches cannabinoid extraction processes using organic solvents such as naphtha, petroleum ether, butane, propane, benzene, isopropyl alcohol or xylenes. However, these types of compounds turn out to be toxic and their use has been discouraged. Ethanol has been the most widely used solvent, either by industrial extraction mechanisms or through plant infusions, alcoholic beverages, or alcohol for topical use.

Despite its wide diffusion, ethanol being a protic polar solvent also dissolves some pigments and waxes, which gives its extracts an unattractive appearance dark and viscous and generates inconveniences from the pharmaceutical point of view. An evolution of the method is the work at temperatures between 50 and 20 degrees Celsius below zero. Ethanol as a solvent is affected by temperature and under these conditions it does not dissolve waxes or most of the plant pigments, thus generating a clearer and cleaner extract. A disadvantage of extraction with ethanol even at low temperatures is the need to use low-pressure distillation equipment or rotary evaporators to remove excess ethanol and leave the compounds of interest in the free phase.

Other extraction methodologies have also been developed v.gr. supercritical CO₂ extraction involving increased technology and infrastructure. CO₂ at supercritical pressure and temperature at a pressure and temperature at which CO₂ is a hybrid between gas and liquid behaves as a very good solvent and, due to its polarity, can dissolve substances of interest such as cannabinoids, leaving behind the vast majority of plant pigments. For this type of extraction, it is necessary to use large-caliber steel in the equipment to withstand the working pressure, making it quite expensive.

In butane extraction, pressurized liquid phase butane is used as a solvent for simple diffusion extraction. The extraction principle follows the same logic of supercritical extraction with CO₂, that is, a solvent is chosen that, when pressurized, passes into a liquid phase so that, after extraction and depressurization, it evaporates easily and leaves behind a complex mixture that contains the substances of interest. The advantage of butane extraction is its low cost compared to supercritical CO₂ extraction and it does not require high-pressure equipment. The disadvantages of this type of extraction are the inherent danger of butane it is a flammable gas and can become explosive in closed environments and the olfactory marker a mercaptan of commercial butane, an unpleasant odor that permeates the oleoresin obtained.

In the state of the art, research has also been found associated with new solvents for extraction, such as hydrofluorocarbons. Antecedents such as US2009305876, US2017113161, CN1356920, WO2008071985, WO8900187, among others, suggest their use, but they entail a series of complex stages, the use of more equipment for many more stages v.gr. heating, agitation, recovery of solvents, etc., the use of more co-solvents and, in general, more certain benefits are not taught in relation to what exists.

Therefore, methods and apparatus are necessary that allow a more efficient extraction of active components from plant material, particularly for the extraction of cannabinoids.

### DETAILED DESCRIPTION FROM THE INVENTION

The present invention presents an improved extraction method that better preserves the terpenes and other compounds of pharmacological or industrial interest present in the plant material, regardless of the part of the plant used for this purpose. In addition, it presents an optimized device for extraction that makes a mixture of solvents in situ, allowing the selective extraction of selected compounds, leaving the vast majority of pigments and vegetable waxes in the remaining biomass.

More particularly, the invention shows a high-efficiency extraction system based on hydrofluorocarbons as solvents, and more particularly the use of 1,1,1,2-tetrafluoroethane and dichlorodifluoromethane, non-flammable, non-explosive and very low-toxic substances that makes it superior to conventional and industrial extraction systems in terms of safety in use.

More particularly, the invention teaches an extraction apparatus that has an internal coeluent (ethanol) preparation device that uses the Joule-Thompson effect to freeze the ethanol and the system, avoiding the inadvertent dragging of pigments and most waxes of plant biomass.

The method of the present invention refers to a method of extracting active components from a plant material that includes the following steps:

Introducing the plant material containing the active components in an extraction chamber (10;100).

Introducing a hydrofluorocarbon compound (HFC) with a dielectric constant between 7 and 10 to a tank (20;200) that has a pressure between 482.6 kPa and 1447.9 kPa (70 psi to 210 psi).

Introducing ethanol in a receptacle (30).

Mixing the hydrofluorocarbon compound (HFC) with ethanol in proportions between 90%-99% for HFCs and 1%-10% for ethanol at pressures equal to or less than 896.3 kPa (130 psi). This mixture in some cases can be done directly in the container that contains ethanol (30) and which in turn is inside the extraction chamber (10) or through industrial devices (350) that can make the mixture before entering to the extraction chamber (100).

Allowing the mixture of the hydrofluorocarbon compound (HFC) and ethanol to reach the plant material found in the extraction chamber (10; 100).

Allowing the enriched mixture of ethanol with the compound of interest and the hydrofluorocarbon solvent to leave the extraction chamber (10;100) to a tank at ambient pressure conditions (50;500), in such a way that the hydrofluorocarbon compound is evaporate immediately, separating from the mixture. Through the outlet valve, the liquid enriched with the oils of the plant material leaves at a temperature close to 30 degrees Celsius below zero and begins its spontaneous evaporation process at room temperature.

Allowing the ethanol to evaporate and separate from the residual mixture more slowly than the hydrofluorocarbon compound at ambient conditions or by means of a current of hot air, obtaining the oil with the active components of the plant material.

Optionally, the hydrofluorocarbon compound is recovered by condensing it and returning it to the pressurized tank by means of a pump (600) and optionally a recovery tank (700).

Optionally, the ethanol is recovered by condensing it and returning it to the mixing bowl.

It should be noted that the plant material can be dried and ground. This greatly facilitates the extraction process.

The extraction methodology of the present invention is based on the use of compounds from the hydrofluorocarbons (HFC) family, which are the evolution of chlorofluorocarbons (CFCs), most of which are banned by many countries because they deplete the carbon layer. of ozone. As such, the HFCs of the present invention are widely used and are considered non-ozone depleting. The choice of HFCs as an alternative extraction medium was considered due to the following aspects:

The specific solubility of bioactive compounds such as vegetable oils in HFC. In the solubility studies of a substance in a particular medium, three basic aspects are taken into account: (i) Chemical aspects (v.gr. neutralization reactions); (ii) Structural aspects (eg presence of related groups); (iii) Electrical aspects (eg dipole moment, dielectric constant). For a solute (bioactive substance such as cannabis oil) to dissolve in a certain solvent (HFC), it is necessary for the solvent to break up the solute molecules and facilitate their solvation; this depends on the dielectric constant of the solvent and the polarity of both the solute and the solvent. For the present case it was found that the use of a substance that increases the dielectric constant of the extraction mixture was necessary. The chosen HFCs have a dielectric constant between 7 and 10.

HFCs were chosen because their boiling temperature is below zero, making it easy to evaporate at room temperature and pressure without the need to apply a heat source, almost completely eliminating external energy sources.

It is a friendly alternative to the environment.

It is a safe alternative. The operating conditions are low pressure compared to extraction with supercritical CO₂ a non-explosive solvent is used unlike extraction with butane, the toxicity of the HFCs used is very low and the manufacture of their equipment, compared to other technologies.

The hydrofluorocarbons (HFCs) that can be used either alone or in a mixture are

1,1,1,2, Tetrafluoroethane

Pentafluoroethane

1,1,1, Trifluoroethane

Difluoromethane

For purposes of the present development, 1,1,1,2, tetrafluoroethane, difluoromethane or their mixtures are preferred.

It is evident that this method has enormous advantages in relation to the processes of the state of the art It must be taken into account that the present methodology can be used for the extraction of any type of component in any variety of plant. However, the inventors have preferred to work with Cannabis sativa, Coffea arabica and Annona muricata. The following table illustrates the present invention in two ways: the first is the one designed in a portable way and the second is the one that has been made at an industrial level by the same inventors. The tests were carried out with plant material from Cannabis sativa L.

The next it is the table.

| | Method used | | | | |
|---|---|---|---|---|---|
| | Extraction | Extraction | Extraction | Portable | Invention |
| Aspect to | CO₂ | subcritical | Super-cooled | Invention | Industry |
| evaluate | supercritical | butane | ethanol | | Level |
| Requirements | Yes, | Not | Yes, team of | Not | Team of |
| additional | material | | ultra-cooling | | Gas recovery |
| structural | for high | | | | |
| | pressures | | | | |
| Risk | Yes | Yes, | Yes, | Not, | Not, |
| Of burst | very high | explosive | extraction | low working | low working |
| | working | gas | liquid | pressures | pressures |
| | pressures | | combustible | and non- | and non- |
| | | | when at room | combustible | combustible |
| | | | temperature | solvent | solvent |
| Need for | Yes | Yes | Not | Not | Not |
| Wax separation | | | | | |
| (Winterization) | | | | | |
| Need to | Yes, it | Yes, it | Yes, it | Not | Not or very |
| rota—evaporation | requires | requires | requires | | little |
| extract | Yes | Yes | Not | Not | Not |
| oleoresin | | | | | |
| extract oildirectly | Not | Not | Not | Yes, with | Yes, with |
| | | | | small | small |
| | | | | amounts of | amounts of |
| | | | | co-eluent | co-eluent |
| Cost | High cost for | Average | Average cost | Low cost per | Low cost per |
| | equipment | cost for | for equipment | equipment | team and |
| | and | equipment | and | and | working |
| | consumables | and | consumables | consumables | hours |
| | | consumables | | | |
| Average yield to | 9%-11% | 10%-11% | 10%-14% | Does not | Does not |
| oleoresin | | | | apply | apply |
| Average yield to | 4.5%-5.5% | 5.0%-5.5% | 5.0%-7.0% | 4.8%-7.0% | 4.8%-7.0% |
| oil | | | | | |
| Terpene | Weak | Weak | Weak | Efficient | Efficient |
| extraction | | | | | |
| Portability | Not | Not | Not | Yes | Not |
| Solvent Toxicity | Not | Yes | Low | Very low | Very low |

In relation to the apparatus for the development of the method, it consists of the following parts:

A pressurized tank (20;200) for the storage of hydrofluorocarbon compounds

A container for the storage of ethanol (30)

An extraction chamber (10, 100) to deposit the plant material to be treated

A device (350) and/or container (30) for mixing ethanol with the hydrofluorocarbon compound.

Piping that connects the hydrofluorocarbon compound storage tank (20; 200), the ethanol storage container (30), the device (350) and/or container (30) for mixing ethanol with the hydrofluorocarbon compound, and the storage chamber. extraction (10;100) to deposit plant material

Extractor outlet pipe

Receiving container (50; 500) of the enriched mixture of hydrofluorocarbon, ethanol and plant extract

Control valves located in intermediate parts of the pipes to control the flow of fluids

One provision may contemplate the non-recovery of the hydrofluorocarbon. The other provision yes. In such a case, the apparatus also consists of the following parts:

A pipe in the upper part of the receiving receptacle (500) of the enriched mixture to remove the vapors of the hydrofluorocarbon compound.

A recovery pump (600) for hydrofluorocarbon vapors connected to the pipe that comes from the recent receipt.

Piping that leads the hydrofluorocarbon recovered from the pump to a recovery tank (700)

A recovery tank (700) for hydrofluorocarbon compounds.

In such a case, the hydrofluorocarbon can be reused, as can the ethanol.

### BRIEF DESCRIPTION OF THE FIGURES

FIG. 1 illustrates an apparatus according to an embodiment of the present invention without recovery of hydrofluorocarbons.

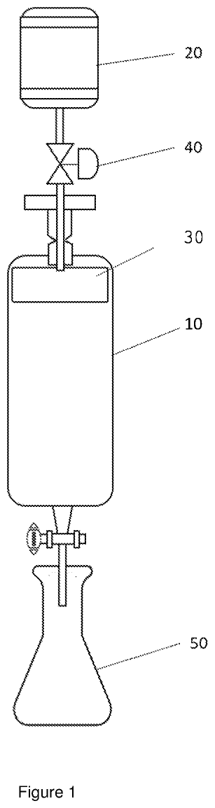

FIG. 2 illustrates an apparatus according to one embodiment of the present invention with recovery of hydrofluorocarbons.

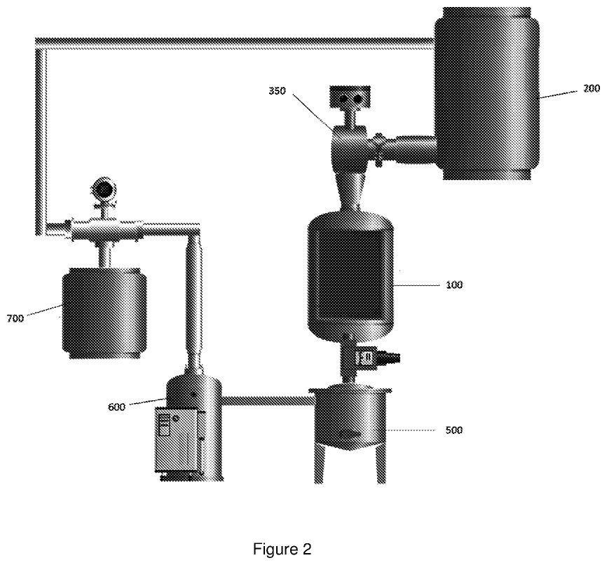

### DESCRIPTION OF THE INVENTION

The same strain of Cannabis sativa L was harvested, dried and ground for extraction with the proposed extraction methodology, using equipment designed by the inventors. The starting weight of plant material for each test was 50 g, the amount of HFC solvent specifically 1,1,1,2-tetrafluoroethane was 340 g and the extraction time was 40 minutes in all cases. The extraction procedure was exactly the same with the only introduction of a variable in the system, which is the amount of coeluent added, in this case the coeluent was 96% ethanol.

The ground plant material is introduced into the device, leaving a headspace for the placement of a glass container with a variable amount of eluant. In all cases, the system was tested for hermeticity to reduce uncertainty.

Once the system is closed, the HFC is slowly released, which, when decompressed, promotes a phenomenon that absorbs energy from its surroundings, causing the temperature of the co-eluent located in the headspace to drop and mixing slowly until it overflows to finally flood the extraction chamber. The residence time of the plant material with the extraction mixture is 40 minutes counted with a stopwatch. After this time, the system is depressurized by opening the outlet valve located at the bottom of the device and allowing the exit of the complex mixture enriched with the compounds of interest.

Once the extraction mixture is evaporated, at room temperature and pressure, the result is a saturated solution of oil with a few grams of ethanol, which can be evaporated by leaving the container open or with the help of a hot air gun.

The oil obtained was weighed to determine the weight yield and subsequently analyzed by high performance liquid chromatography for the quantitative determination of the cannabinoids THC, THCA, CBD, CBA and CBG.

8 experiments were selected within the trial where the HFC/coeluent ratio was varied as shown in the tables below.

The first table shows the weight yield, that is, how the amount of oil that is extracted varies as a function of the amount of coeluent added.

| | | | Empty | Bottle | | |
|---|---|---|---|---|---|---|
| | Vegetal | | bottle | weight plus | Extract | |
| | Material | Coeluent | weight | extract | Weight | Yield |
| | (g) | (g) | (g) | (g) | (g) | % |
| El | 53.95 | 0 | 141.18 | 141.89 | 0.71 | 1.32% |
| E2 | 50.54 | 2 | 51.63 | 52.25 | 0.62 | 1.23% |
| E3 | 50.64 | 5 | 52.49 | 53.45 | 0.96 | 1.90% |
| E4 | 50.5 | 8 | 51.78 | 54 | 2.22 | 4.40% |
| E5 | 50.24 | 10 | 51.74 | 54.16 | 2.42 | 4.82% |
| E6 | 50.29 | 12 | 51.72 | 53.89 | 2.17 | 4.31% |
| E7 | 50.02 | 15 | 51.84 | 55.16 | 3.32 | 6.64% |
| E8 | 50.04 | 20 | 51.9 | 55.8 | 3.9 | 7.79% |

The following table shows the yield of the extraction in composition of cannabinoids.

| | | | | | | | Total | mg | Weight | Total mg |
|---|---|---|---|---|---|---|---|---|---|---|
| | CBD | CBG | CBDA | CBN | THC | THCA | % | cannabinoids | extract | cannabinoids |
| El | 0.9 | 1.14 | Nd | 0.91 | 31.9 | 3.74 | 38.59 | 385.9 | 0.7 | 274.0 |
| E2 | 0.96 | 1.18 | Nd | 0.89 | 30.56 | 3.28 | 36.87 | 368.7 | 0.6 | 228.6 |
| E3 | 0.83 | 1.09 | Nd | 0.83 | 31.53 | 2.56 | 36.84 | 368.4 | 1.0 | 353.7 |
| E4 | 0.92 | 1.19 | Nd | 0.8 | 32.48 | 1.66 | 37.05 | 370.5 | 2.2 | 822.5 |
| E5 | 0.7 | 1.01 | Nd | 0.69 | 29.34 | 1.4 | 33.14 | 331.4 | 2.4 | 802.0 |
| E6 | 0.79 | 1.24 | Nd | 0.76 | 36.18 | 1.83 | 40.8 | 408.0 | 2.2 | 885.4 |
| E7 | 0.8 | 1.3 | Nd | 0.71 | 34.87 | 1.23 | 38.91 | 389.1 | 3.3 | 1291.8 |
| E8 | 0.72 | 1.18 | Nd | 0.7 | 31.24 | 1.03 | 34.87 | 348.7 | 3.9 | 1359.9 |

1. A method of extracting active components from a plant material comprising the following steps:
introducing the plant material containing the active components in an extraction chamber;
introducing a hydrofluorocarbonated compound (HFC) with a dielectric constant between 7 and 10 into a tank that has a pressure between 482.6 kPa and 1447.9 kPa (70 psi to 210 psi);
introducing ethanol in a receptacle;
mixing the hydrofluorocarbonated compound (HFC) with the ethanol in proportions between 90%-99% for HFCs and 1%-10% for ethanol at pressures equal to or less than 896.3 kPa (130 psi);
percolating the mixture of the hydrofluorocarbonated compound (HFC) and ethanol through the plant material found in the extraction chamber;
evacuating the enriched mixture of ethanol, the compound of interest, and the hydrofluorocarbonated solvent from the extraction chamber into a receptacle at ambient pressure conditions, wherein the hydrofluorocarbon compound evaporates immediately, separating from the mixture;
evaporating and separating the ethanol from the residual at ambient conditions or by a current of hot air stream to obtain an oil with the active components of the plant material.

2. The extraction method according to claim 1, wherein the plant material is previously dried.

3. The extraction method according to claim 1, wherein the plant material is previously ground.

4. The extraction method according to claim 1, wherein the hydrofluorocarbonated compound is chosen from 1,1,1,2-tetrafluoroethane, pentafluoroethane, 1,1,1, trifluoroethane, difluoromethane, dichlorodifluoromethane, or mixtures thereof.

5. The extraction method according to claim 1, wherein the plant material is chosen from Cannabis sativa, Coffea arabica, or Annona muricata.

6. An apparatus for extracting active components from a plant comprising:
a pressurized tank (20;200) for storing hydrofluorocarbonated compounds;
a container for storing ethanol (30);
an extraction chamber (10, 100) to deposit the plant material to be treated;
a device (350) and/or container (30) for mixing the ethanol with the hydrofluorocarbonated compound;
pipes connecting the hydrofluorocarbonated compound storage tank (20; 200), the ethanol storage container (30), the device (350) and/or container (30) for mixing ethanol with the hydrofluorocarbonated compound, and the extraction chamber (10;100) to deposit plant material;
an exhaust pipe outlet;
a receiving container (50; 500) of the enriched mixture of hydrofluorocarbonated, ethanol, and plant extract;
control valves located in intermediate parts of the pipes to control the flow of fluids.

7. The apparatus according to claim 6, wherein the apparatus does not recover hydrofluorocarbons.

8. The apparatus according to claim 6, wherein the apparatus recovers hydrofluorocarbons.

9. The extraction method according to claim 1, wherein the hydrofluorocarbonated compound is recovered by condensing it and returning it to the pressurized tank.

10. The extraction method according to claim 1, wherein the ethanol is recovered by condensing it and returning it to the mixing receptacle.

11. The apparatus for extracting active components according to claim 6, further including a device for the recovery of hydrofluorocarbonated compounds comprising:
a pipe at a top of the receiving container (500) of the enriched mixture to remove the vapors of the hydrofluorocarbonated compound;
a recovery pump (600) for hydrofluorocarbonated vapors connected to the pipe that comes from the recent receipt;
piping that leads the hydrofluorocarbonated recovered from the recovery pump to a recovery tank (700); and
the recovery tank (700) storages the hydrofluorocarbonated compounds.
